(19) United States
(12) Patent Application Publication
(10) Pub. No.: US 2012/0070124 A1
(43) Pub. Date: Mar. 22, 2012

(54) IMAGE CAPTURING APPARATUS, IMAGE CAPTURING METHOD, AND COMPUTER READABLE MEDIUM

(75) Inventors: Koshi Tokunaga, Kawasaki-shi (JP); Kazuya Shinozaki, Tokyo (JP)

(73) Assignee: CANON KABUSHIKI KAISHA, Tokyo (JP)

(21) Appl. No.: 13/230,464

(22) Filed: Sep. 12, 2011

(30) Foreign Application Priority Data
Sep. 17, 2010 (JP) 2010-209846

(51) Int. Cl. H04N 5/77

(52) U.S. Cl. 386/224; 386/E05.069

(57) ABSTRACT

To make it possible, when an audio file is reproduced before capturing of a moving image, to prevent the sound from being recorded during capturing. When a short-time moving image capturing mode is set, a through-the-lens image is displayed and an audio file is reproduced. When a first shutter switch is pressed while the audio file is reproduced, the audio file stops being reproduced and automatic focus control is performed. Alternatively, the audio file starts being reproduced when the first shutter switch is pressed. The audio file stops being reproduced when a second shutter switch is pressed.

### BACKGROUND OF THE INVENTION

1. Field of the Invention

The present invention relates to an image capturing apparatus, an image capturing method, and a computer readable medium.

2. Description of the Related Art

Image capturing apparatuses that store moving image data combined with audio data have heretofore been known (for example, see Japanese Patent Application Laid-Open No. 2006-261957). Among known functions for capturing a moving image is to repeat short-time shooting, rearrange the captured moving images, and add back ground music (BGM) for reproduction. Such a function can be used to easily create a moving image that is similar to ones edited on a personal computer (PC). For example, there is known an image capturing apparatus that allows easy creation of moving images for public presentation and other purposes without editing operations after the capturing of the moving images.

The function of the foregoing apparatus is predicated on the addition of an audio file to moving images for reproduction. Therefore, the user often plays the audio file to be added while capturing moving images so that the moving images can be shot as the user imagines. There is a problem, however, that the sound is recorded through a microphone since the audio file is reproduced even after the start of capturing of the moving image.

### SUMMARY OF THE INVENTION

The present invention is directed to preventing sound from being recorded during image capturing when an audio file is reproduced before capturing of a moving image.

According to an aspect of the present invention, there is provided an image capturing apparatus which includes an image capturing unit configured to capture a moving image to generate moving image data; a display control unit configured to display the moving image captured by the image capturing unit on a display unit; a recording unit configured to record the moving image data generated by the image capturing unit onto a recording medium; an instruction unit configured to issue an instruction for processing related to the the recording of the moving image data by the recording unit; a reproduction unit configured to reproduce audio data to output sound from a speaker while the moving image is displayed on the display unit; and a control unit configured to control the reproduction unit to stop outputting sound from the speaker when the instruction unit issues the instruction for the processing related to the the recording of the moving image data while the audio data is reproduced.

According to an aspect of the present invention, it is possible to capture a moving image suited to sound as the user imagines, and prevent the sound from being recorded when the user shoots a short-time moving image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration example of a digital camera according to an exemplary embodiment.

FIGS. 2A-B comprise a flowchart illustrating an example of a processing procedure for capturing a moving image.

FIG. 3 is a diagram illustrating examples of setting screens and select screens.

FIGS. 4A-B comprise a flowchart illustrating an example of a processing procedure for capturing a moving image.

### DESCRIPTION OF THE EMBODIMENTS

Various exemplary embodiments, features, and aspects of the invention will be described in detail below with reference to the drawings.

The present invention is not limited to the following exemplary embodiments. The exemplary embodiments of the present invention are intended to illustrate modes which represent examples of the invention, and are not intended to limit the scope of the invention.

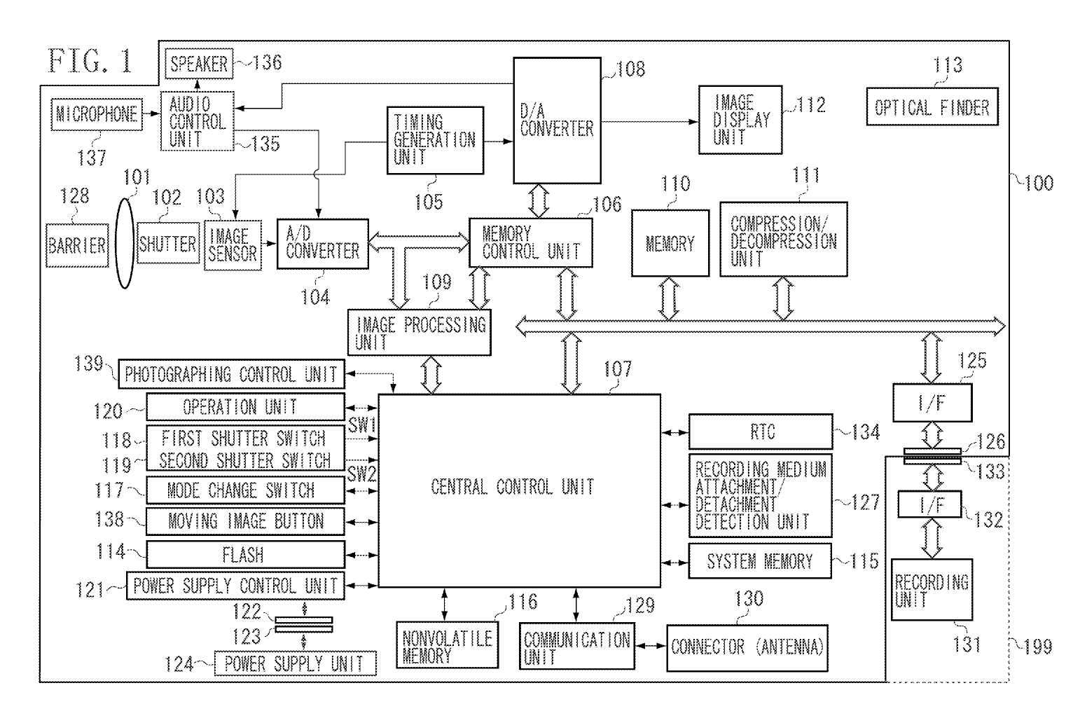

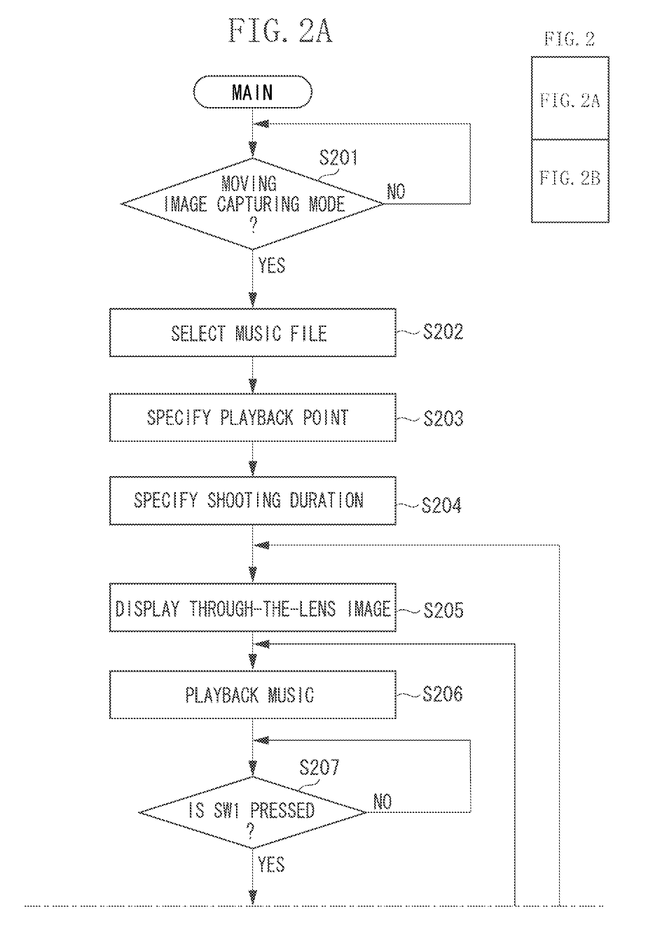

FIG. 1 is a block diagram illustrating a configuration example of a digital camera 100 according to the present exemplary embodiment. As illustrated in FIG. 1, the digital camera 100 includes a shooting lens 101 and a shutter 102, through which an optical image is formed on an image sensor 103. The shutter 102 has the function of adjusting a diagraph amount. The image sensor 103 converts the formed optical image into an electrical signal and outputs the analog signal. The image sensor 103 may be a known sensor device such as CCD and CMOS image sensors. An A/D converter 104 converts the analog signal output from the image sensor 103 into digital data.

A timing generation unit 105 is controlled by a memory control unit 106 and a central control unit 107, and supplies a clock signal and control signals to the image sensor 103, the A/D converter 104, and a D/A converter 108. An image processing unit 109 performs predetermined pixel interpolation processing and color conversion processing on the digital data from the A/D converter 104 and data that is supplied from the memory control unit 106. The image processing unit 109 also performs predetermined arithmetic processing by using captured image data, and supplies the calculations to the central control unit 107. The image processing unit 109 also performs predetermined arithmetic processing by using captured image data, and implements through-the-lens (TTL) metering automatic white balance (AWB) processing based on the calculations.

The central control unit 107 controls the lens position of the shooting lens 101 and the diaphragm amount of the shutter 102 to perform TTL metering automatic focus (AF) control and automatic exposure (AE) control based on the calculations obtained in the image processing unit 109. The central control unit 107 also controls a flash 114 to implement TTL metering electronic flash preliminary emission (EF) based on the calculations obtained in the image processing unit 109.

The memory control unit 106 controls the A/D converter 104, the timing generation unit 105, the image processing unit 109, the D/A converter 108, a memory 110, and a compression/decompression unit 111. Digital data from the A/D converter 104 is written into the memory 110 (or an additionally-provided image display memory) as image data through the image processing unit 109 and the memory control unit 106 or directly through the memory control unit 106.

The image data written in the memory 110 is displayed as an image or images on an image display unit 112 through the D/A converter 108. The image display unit 112 includes a thin-film transistor (TFT) based liquid crystal display (LCD), for example. The digital camera 100 according to the present exemplary embodiment can implement an electronic viewfinder (EVF) function by displaying captured image data on the image display unit 112 successively. The display of the image display unit 112 can be turned ON/OFF according to an instruction from the central control unit 107. Turning OFF the display control on the image display unit 112 can significantly reduce the power consumption of the digital camera 100. When the user uses an optical finder 113 for shooting, the user may operate an operation unit 120 to give an instruction to turn OFF the display control to save power.

The memory 110 stores still image data and moving image data that are acquired by shooting. The memory 110 has a recording capacity sufficient to store a predetermined number of pieces of still image data and a predetermined duration of moving image data. The digital camera 100 can thus write a large amount of image data to the memory 110 at high speed even in the cases of continuous shooting and panoramic shooting where a plurality of still images are captured in succession. The memory 110 is also used as a work area of the central control unit 107.

The compression/decompression unit 111 compresses image data (encodes data) and decompresses image data (decodes data) based on an adaptive discrete cosine transform (ADCT). For example, the compression/decompression unit 111 reads image data stored in the memory 110, performs compression processing or decompression processing, and writes the processed data to the memory 110.

An audio control unit 135 operates under the control of the central control unit 107. The audio control unit 135 accepts audio data, which is an analog signal converted by the D/A converter 108, and controls audio outputs to a speaker 136 through a not-illustrated amplifier circuit and to an earphone plugged in a not-illustrated earphone jack. The audio control unit 135 also controls an audio input under the control of the central control unit 107, whereby audio data, which is an analog signal input from a microphone 137, is passed through an amplifier circuit and output to the A/D converter 104.

A photographing control unit 139 controls the shutter 102 under the control of the central control unit 107. For example, the photographing control unit 139 controls the shutter 102 in association with the flash 114, thereby implementing a flash light amount control. The photographing control unit 139 also controls focusing of the shooting lens 101 under the control of the central control unit 107. Specifically, the photographing control unit 139 performs a drive control on the lens position of a focus lens in the shooting lens 101. For example, with TTL metering, the image processing unit 109 performs arithmetic processing on captured image data, and the central control unit 107 controls the photographing control unit 139 based on the calculations. The photographing control unit 139 also controls zooming of the shooting lens 101 under the control of the central control unit 107. Specifically, the photographing control unit 139 performs a drive control on the lens position of a zoom lens in the shooting lens 101. The photographing control unit 139 also controls opening/closing of a covering member (a barrier 128) under the control of the central control unit 107. The barrier 128 is intended to protect the shooting lens 101.

The central control unit 107 controls the entire digital camera 100. Specifically, the central control unit 107 reads program data recorded in a system memory 115, expands the program data into the work area of the memory 110, and controls the operation of the entire digital camera 100 in cooperation with the program data expanded.

The optical finder 113 projects incident light from the shooting lens 101 onto a screen to optically display a subject image. For the sake of projection, the optical finder 113 uses a mirror and a pentagonal prism lying between the shooting lens 101 and the image sensor 103. The mirror is flipped up at the time of exposure of the image sensor 103. The use of the optical finder 113 allows the digital camera 100 according to the present exemplary embodiment to carry out shooting without using the electronic finder function of the image display unit 112. The optical finder 113 may include part of the image display unit 112 described above.

The flash 114 emits light under the control of the central control unit 107, thereby irradiating a subject with auxiliary light. The flash 114 may have a light projection function of irradiating a subject with auxiliary light during AF control, and a flash light amount control function of adjusting the amount of light to irradiate a subject.

The system memory 115 stores constants, variables, and program data for operation of the central control unit 107. The system memory 115 also contains a program diagram for AE use. The program diagram is data to be consulted during TTL metering AE control. The program diagram is in the form of table data in which control values such as a diaphragm amount and a shutter speed are previously defined with respect to luminance values and other calculations obtained by the image processing unit 109.

In the digital camera 100 according to the present exemplary embodiment, the central control unit 107 controls the image display unit 112 and the audio control unit 135 by the central control unit 107 executing programs. The digital camera 100 thereby presents operation statuses and messages to the user by using characters, images, and sound. The components intended for the user presentation, such as the image display unit 112 and the speaker 136, are arranged, for example, in an easily visible position near the operation unit 120 of the digital camera 100. The image display unit 112 is arranged in part in the optical finder 113. Some information can be presented by the image display unit 112 located in the optical finder 113.

The digital camera 100 presents operation statuses and messages to the user from the image display unit 112 and the speaker 136 and then accepts user operations from the operation unit 120 under the control of the central control unit 107. For example, when specifying data to be transferred from an external device to be described later, the image display unit 112 displays a screen for specifying data, and the operation unit 120 accepts a user specification.

In addition to the screen for specifying data to be transferred, the LCD of the image display unit 112 may display information on operation statuses related to photographing and operation statuses related to other than photographing. Examples of the operation statuses to be displayed related to photographing include a single shot/continuous shooting indication, a self-timer indication, a compression rate indication, a recording pixel number indication, a recorded image number indication, a residual shot number indication, a shutter speed indication, a diaphragm value indication, and an exposure compensation indication. A flash indication, a red-eye reduction indication, and a macro photography indication may also be included. Examples of the operation statuses to be displayed related to information other than photographing include a buzzer setting indication, a clock battery level indication, a battery level indication, an error indication, a numeral display of information in a plurality of digits, an attachment/detachment status indication of a recording medium 199, a communication interface (I/F) operation indication, and a date and time display. Examples of the display contents of the image display unit 112 to be displayed inside the optical finder 113 include an in-focus indication, a camera-shake warning indication, a flash charge indication, a shutter speed indication, a diaphragm value indication, and an exposure indication.

A nonvolatile memory 116 is a memory that is electrically erasable and recordable. For example, the nonvolatile memory 116 may be an electrically erasable and programmable read-only memory (EEPROM). A mode change switch 117 is a switch for the user to set and change function modes, which include power OFF, an automatic shooting mode, a shooting mode, a panoramic shooting mode, a playback mode, a multi-screen reproduction/deletion mode, and a PC connection mode. In the present exemplary embodiment, one of the function modes is a short-time moving image capturing mode.

A first shutter switch 118 (SW1) is a switch that turns ON in the middle of an operation on a not-illustrated shutter button (for example, when the shutter button is half-pressed). In response to the ON input from the first shutter switch 118, the central control unit 107 starts, as first instructing, an operation related to preparation for recording processing, such as AF, AE, AWB, and EF operations.

A second shutter switch 119 (SW2) is a switch that turns ON at the completion of the operation on the shutter button (for example, when the shutter button is fully pressed). In response to the ON input from the second shutter switch 119, the central control unit 107 performs, as second instructing, a series of operations related to photographing, including exposure processing, development processing, and recording processing. In the exposure processing, the central control unit 107 reads a signal (analog signal) from the image sensor 103, and writes the signal into the memory 110 as digital data through the A/D converter 104 and the memory control unit 106. In the development processing, the central control unit 107 makes the image processing unit 109 and the memory control unit 106 apply image processing to the digital data written in the memory 110, and writes the image-processed digital data into the memory 110. In the recording processing, the central control unit 107 reads the digital data that is written into the memory 110 after the development processing, compresses the digital data by using the compression/decompression unit 111, and writes the compressed data to a recording medium 199. The central control unit 107 instructs to start recording in such a manner.

The operation unit 120 includes various types of buttons and a touch panel. Specifically, the operation unit 120 includes a menu button, menu shift buttons, and a set button for displaying various setting menus and making settings. For example, when specifying data to be transferred from an external device as described later, the user uses the menu shift buttons to select a piece of data from a plurality of data candidates, and uses the set button to specify the piece of data as the data to be transferred. The operation unit 120 also includes various types of setting buttons for image capturing, including a macro button, a flash setting button, a single shot/continuous shooting/self-timer switch button, an exposure compensation button, and a shooting image quality select button. The operation unit 120 also includes a multi-screen reproduction and page-advance button, a reproduced image scroll button, and a date/time setting button. The multi-screen reproduction and page-advance button and the reproduced image scroll button are intended to reproduce captured images, and select and set images to be output. The date/time setting button is intended for date and time setting.

The digital camera 100 also includes a moving image button 138 for accepting user instructions to start and end capturing a moving image. The digital camera 100 starts capturing a moving image if the moving image button 138 is pressed when no moving image is being captured. The digital camera 100 ends capturing a moving image if the moving image button 138 is pressed when the moving image is being captured. If the short-time moving image capturing mode is set, the second shutter switch 119 (SW2) is used to start capturing a moving image. The digital camera 100 automatically ends capturing the moving image after a lapse of a predetermined time. The digital camera 100 may include a user interface for setting a white balance (WB) operation for still image photographing during moving image capturing. When setting the WB operation for the still image photographing during moving image capturing, the user may select a mode from the following three modes: a color reproducibility priority mode, a moving image priority mode, and a still image priority mode.

A power supply control unit 121 includes a battery detection circuit, a DC-DC converter, and a switch circuit for switching blocks to power on (none of which is illustrated). The power supply control unit 121 detects battery connection and the output voltage of the battery, and controls power supply to various components of the digital camera 100 under the control of the central control unit 107. Connectors 122 and 123 connect the power supply control unit 121 and a power supply unit 124. The power supply unit 124 supplies power to the digital camera 100. Examples of the power supply unit 124 include primary batteries such as an alkaline battery and a lithium battery, secondary batteries such as a NiCd battery, a NiMH battery, and a Li battery, and AC adaptors.

An I/F 125 communicably connects an internal bus and the recording medium 199 which is connected through a connector 126. The connector 126 makes electrical and physical connection with the recording medium 199 to allow communication between the recording medium 199 and the I/F 125. A recording medium attachment/detachment detection unit 127 is a switch that detects the physical connection between the connector 126 and the recording medium 199. The recording medium attachment/detachment detection unit 127 detects whether or not the recording medium 199 is attached to the connector 126, and outputs the resulting detection signal to the central control unit 107.

The present exemplary embodiment deals with a case where the digital camera 100 includes a single system of an interface and a connector for attaching a recording medium 199. It will be understood that the digital camera 100 may include one or a plurality of systems of interfaces and connectors for attaching a recording medium 199. The digital camera 100 may include interfaces and connectors of different standards in combination. Interfaces and connectors compliant with Secure Digital (SD) memory card standards may be used. If a communication card is attached to the connector 126, the digital camera 100 can transfer image data and management information that accompanies image data to/from other computers and peripheral devices including a printer. Examples of the communication card include a local area network (LAN) card, a modem card, a Universal Serial Bus (USB) card, an Institute of Electrical and Electronics Engineers (IEEE) 1394 card, a P1284 card, a small computer systems interface (SCSI) card, and a personal handyphone system (PHS) data communication card.

The barrier 128 covers an image capturing unit of the digital camera 100 including the photographing lens 101 to avoid stains and breakage of the image capturing unit. A communication unit 129 transmits and receives data to/from external devices by wired or wireless serial/parallel communications, using Recommended Standard 232 version C (RS232C), USB, IEEE 1394, P1284, SCSI, modem, LAN, and/or wireless communications. A connector (antenna) 130 connects the digital camera 100 to other devices (external devices) through the communication unit 129. The connector (antenna) 130 is an ordinary connector if the connection is in a wired form, and an antenna if the connection is in a wireless form.

A real time clock (RTC) 134 outputs time information under the control of the central control unit 107. The RTC 134 includes an internal power supply apart from the power supply control unit 121, and can perform clocking without being powered by the power supply unit 124. The recording medium 199 is a memory card or a hard disk drive that is detachably attached to the digital camera 100 through the connector 126. The recording medium 199 includes a recording unit 131 that includes a semiconductor memory and/or a magnetic disk, and an I/F 132 for connecting the recording unit 131 to the digital camera 100. The recording medium 199 also includes a connector 133 that is intended to connect electrically and physically to the digital camera 100 through the connector 126.

The central control unit 107 of the digital camera 100 may be a single piece of hardware or include a plurality of pieces of hardware. Such pieces of hardware may cooperate to implement functions as a central control unit 107. Data to be supplied to external devices, such as image data captured by the image sensor 103, shall be stored in the recording unit 131 of the recording medium 199 in advance. Program data for controlling the digital camera 100 is recorded in the nonvolatile memory 116. The program data is expanded in the memory 110 at runtime, and the central control unit 107 executes the expanded program data. As the central control unit 107 executes the program data, the digital camera 100 loads image data stored in the recording unit 131, and reproduces and displays the image data on the image display unit 112. The digital camera 100 also performs processing described later to supply image data stored in the recording unit 131 to an external device that is connected through the communication unit 129, or acquire specified image data from the external device. While the description of the present exemplary embodiment deals with a digital camera that can capture a moving image, the exemplary embodiment is also applicable to digital single-lens reflex cameras and digital camcorders.

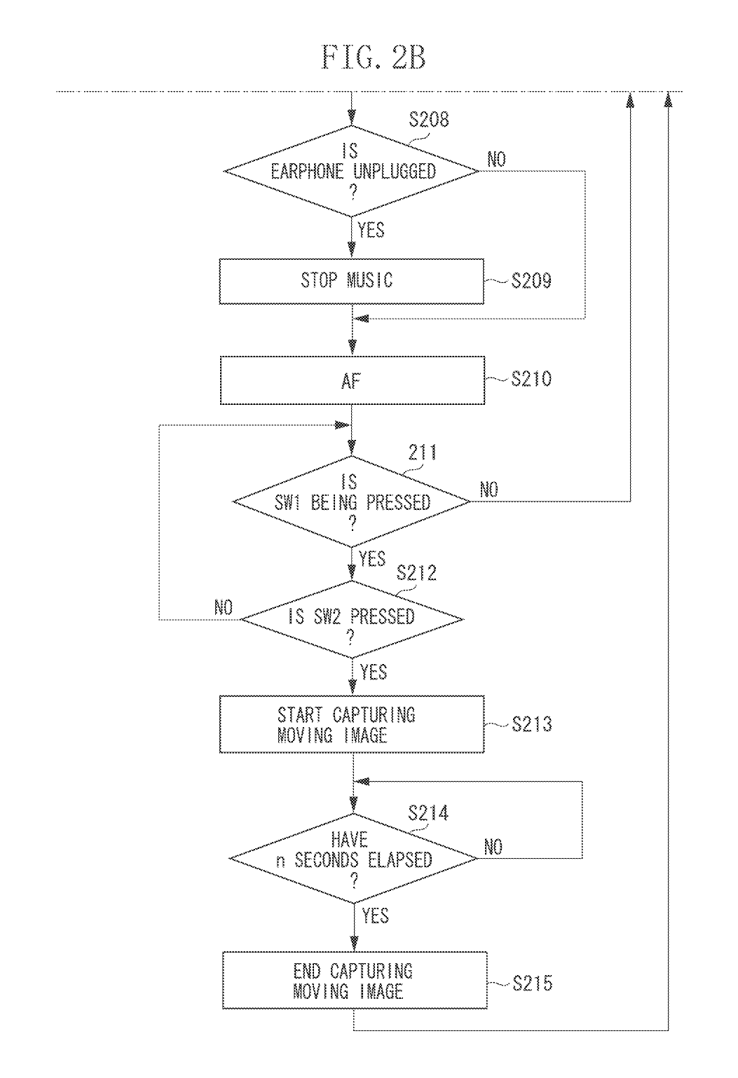

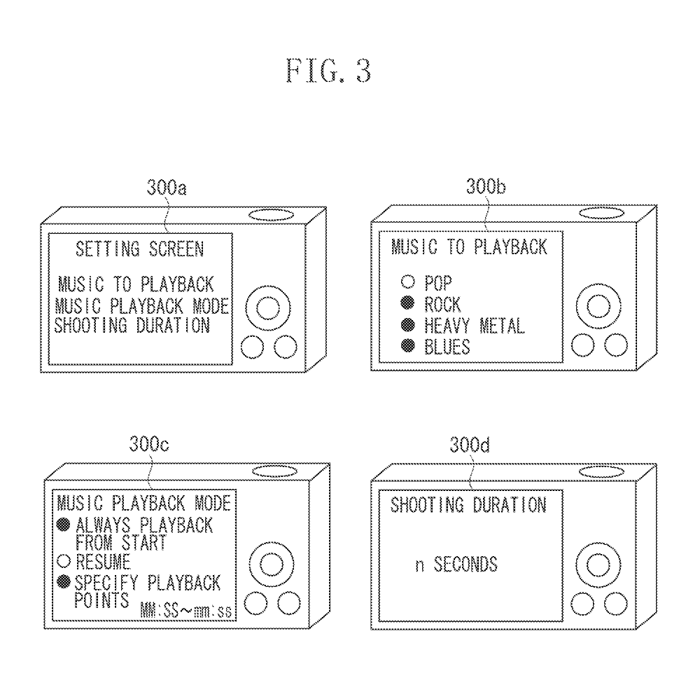

Next, processing that is performed by the control of the central control unit 107 of the digital camera 100 will be described with reference to FIGS. 2 and 3.

FIG. 2 is a flowchart illustrating an example of a processing procedure for capturing a moving image. The processes illustrated in FIG. 2 are performed by the control of the central control unit 107.

In step S201, the central control unit 107 initially waits until it is detected that the user sets the short-time moving image capturing mode by using the mode change switch 117 of the digital camera 100.

If the short-time moving image capturing mode is set (YES in step S201), then in step S202, the user determines a music file to select. Specifically, the central control unit 107 initially displays a setting screen 300a such as illustrated in FIG. 3 on the image display unit 112. In the present exemplary embodiment, the central control unit 107 displays the setting screen 300a when the short-time moving image capturing mode is set. However, such display may be arbitrarily set from a setting menu. In the short-time moving image capturing mode, the central control unit 107 displays a setting menu like illustrated in the setting screen 300a of FIG. 3, for example. The setting menu illustrated in the present exemplary embodiment includes three items “MUSIC TO PLAY,” “ MUSIC PLAY MODE,” and “SHOOTING DURATION.” The following description will be given on the assumption that the user selects “MUSIC TO PLAY” by using the operation unit 120.

When the user operates the operation unit 120 to select “MUSIC TO PLAY” on the setting screen 300a, the central control unit 107 then displays a select screen 300b on the image display unit 112. In the present exemplary embodiment, four pieces of music are stored in the recording medium 199 or the nonvolatile memory 116 as files or data in advance. The user can select the stored pieces of music on the select screen 300b. The select screen 300b of FIG. 3 illustrates the state where “POP” is selected. When the user operates the operation unit 120 to select a piece of music on the select screen 300b, the central control unit 107 returns to the setting screen 300a.

In step S203, the user specifies a play point. Specifically, when the user selects “MUSIC PLAY MODE” on the setting screen 300a, the central control unit 107 displays a select screen 300c on the image display unit 112. The select screen 300c is intended to set a music play mode, and includes three items “PLAY FROM START,” “RESUME,” and “SPECIFY PLAY POINTS.” If “PLAY FROM START” is selected, the music file is always reproduced from the start even after the reproduction of the music file is interrupted by image capturing. If “RESUME” is selected, the music file is reproduced from an interrupted point after the reproduction of the music file is interrupted by image capturing. If “SPECIFY PLAY POINTS” is selected, the user specifies the play points of the music in advance. The music file is reproduced only between the specified points. In the present exemplary embodiment, the play points are specified in terms of time. The select screen 300c of FIG. 3 illustrates the state where “RESUME” is selected. When the user operates the operation unit 120 to select any one of the play modes illustrated in the select screen 300c, the central control unit 107 returns to the setting screen 300a.

In step S204, the user specifies the shooting duration. Specifically, when the user selects “SHOOTING DURATION” on the setting screen 300a, the central control unit 107 displays a setting screen 300d on the image display unit 112. In an ordinary mode of moving image capturing, the digital camera 100 captures a moving image between when the moving image button 138 is pressed and when the image button 138 is pressed again. In the short-time moving image capturing mode, the digital camera 100 captures a moving image for a previously set duration, and automatically ends capturing an image after a lapse of the set duration. The shooting duration specified in step S204 is the duration of the capturing in the short-time moving image capturing mode. The central control unit 107 sets the duration to capture a moving image on the setting screen 300d based on user instructions.

Ending the settings of steps S202 to S204, the central control unit 107 dismisses the setting screen 300d displayed on the image display unit 112. In step S205, the central control unit 107 performs processing of displaying a through-the-lens image on the image display unit 112. The processing of displaying a through-the-lens image refers to processing of displaying captured images on the image display unit 112 in succession. Specifically, the central control unit 107 inputs the signal (analog signal) read from the image sensor 103 into the D/A converter 108 through the A/D converter 104 and the memory control unit 106 so that the real-time images are displayed on the image display unit 112 in succession.

In step S206, the central control unit 107 reproduces the music file. Specifically, the central control unit 107 initially expands the music file stored in the recording medium 199 or the nonvolatile memory 116 into the memory 110. The central control unit 107 also expands a music reproduction program stored in the nonvolatile memory 116 into the memory 110. The central control unit 107 reproduces the music file by using the expanded music reproduction program, and makes the audio control unit 135 output the music from the speaker 136 or the like. The reproduction is performed according to the settings made in steps S202 and S203.

In step S207, the central control unit 107 waits until the user presses the first shutter switch 118 (SW1). If the first shutter switch 118 (SW1) is detected to be pressed (YES in step S207), then in step S208, the central control unit 107 determines whether or not an earphone is plugged in the not-illustrated earphone jack. If it is determined that there is an earphone plugged in (NO in step S208), the music is not recorded since the music is not output from the speaker 136. The central control unit 107 therefore proceeds to step S210. On the other hand, if it is determined in step S208 that there is no earphone plugged in (YES in step S208), the central control unit 107 proceeds to step S209.

In step S209, the central control unit 107 stops reproducing the music file. More specifically, the central control unit 107 stops reproducing the music file according to the music reproduction program expanded in the memory 110. The central control unit 107 thereby prevents the music from being output from the speaker 136. If the play mode is set to reproduce the music file from the interrupted point, the central control unit 107 stores information on the reproduction stop position of the music into the memory 110. In step S210, the central control unit 107 performs AF processing by using the photographing control unit 139. Since the AF processing is technically obvious, detailed description thereof will be omitted.

In step S211, the central control unit 107 then determines whether or not the first shutter switch 118 (SW1) is held down. If the first shutter switch 118 (SW1) is determined to be held down, i.e., continues to be pressed from step S207 (YES in S211), the central control unit 107 proceeds to step S212. On the other hand, if it is determined in step S211 that the first shutter switch 118 (SW1) stops being pressed (is released; NO in step S211), the central control unit 107 returns to step S206.

In step S212, the central control unit 107 determines whether or not the second shutter switch 119 (SW2) is pressed. If the second shutter switch 119 (SW2) is determined not to be pressed (NO in step S212), the central control unit 107 returns to step S211. On the other hand, if it is determined in step S212 that the second shutter switch 119 (SW2) is pressed (YES in step S212), then in step S213, the central control unit 107 starts recording the moving image. Specifically, the central control unit 107 accumulates frame data of the moving image acquired by image capturing processing (moving image frames) in the memory 110, and records the moving image frames on the recording medium 199 through the I/Fs 125 and 132. The recording method here depends on the moving image format. If the moving image is an uncompressed one such as motion joint photographic group (Motion JPG) moving image, the central control unit 107 stores the moving image frames without compression by the compression/decompression unit 111. If the moving image is a compressed one such as MOV, the central control unit 107 compresses the moving image frames by using the compression/decompression unit 111 and stores the compressed moving image frames. Since the method of compressing moving image frames is technically obvious, detailed description thereof will be omitted.

In step S214, the central control unit 107 continues capturing an image until a lapse of n seconds in shooting time. Here, the central control unit 107 compares the current shooting time with the duration previously set in step S204. If the current shooting time reaches the set duration (YES in step S214), then in step S215, the central control unit 107 stops recording the moving image and returns to step S205. Specifically, the central control unit 107 stops the processing of recording the frame data of the moving image acquired by the image capturing processing on the recording medium 199. The central control unit 107 then adds photographic information on the moving image to the moving image file, and inserts a symbol indicating the end of file to complete the generation of the moving image file. The photographic information includes information on photographing date and time and photographing conditions. Information on the music file reproduced before the capturing of the moving image is also included in the photographic information.

Ending capturing the moving image in step S215, the central control unit 107 returns to step S205 to display a through-the-lens image. In step S206, the central control unit 107 restarts to reproduce the music file. The central control unit 107 restarts to reproduce the music file according to the setting made in step S203. If “PLAY FROM START” is selected, the central control unit 107 reproduces the music file from the start. If “RESUME” is selected, the central control unit 107 resumes reproduction from the stop point that is recorded in the memory 110 in step S209. If “SPECIFY PLAY POINTS” is selected, the central control unit 107 starts reproduction at the specified point. By such processing, the central control unit 107 reproduces the music file as an audio file before capturing a short-time moving image, and stops reproducing the audio file during capturing.

As a result of the foregoing image capturing, a moving image file captured for a short time is recorded on the recording medium 199 that is mounted on the digital camera 100. Now, when the user operates the mode change switch 117 to switch to the playback mode, the central control unit 107 groups moving image files that are captured for a short time. Information on photographing date and time and information on music files reproduced before the recording of the moving image files are recorded in metadata. The central control unit 107 performs the grouping by using such information.

When reproducing moving image files in the playback mode, the central control unit 107 displays representative thumbnails of the respective moving images on the image display unit 112 in an index fashion. When the user selects a thumbnail, the central control unit 107 reproduces a music file recorded in metadata, and reproduces moving images in that group in succession.

The digital camera 100 makes similar operations when combining a plurality of moving image files captured for a short time into a single file. When the user makes an operation to instruct to combine moving images, the central control unit 107 performs processing to group moving images captured for a short time by using photographing date and time and information on music files recorded in metadata, and connect a plurality of moving files in ascending order along the time axis. The central control unit 107 then combines a reproduced music file with the single connected moving image file in association with each other, and records the resultant on the recording medium 199 as a moving image file.

As has been described above, according to the present exemplary embodiment, the central control unit 107 stops reproducing a music file when the first shutter switch 118 (SW1) is pressed. This makes it possible to capture a moving image suited to sound as the user imagines, and prevent the sound from being recorded when the short-time moving image capturing mode is set.

A second exemplary embodiment of the present invention will be described below. The first exemplary embodiment has dealt with the case where the central control unit 107 stops playing music when the first shutter switch 118 (SW1) is pressed. In contrast, the present exemplary embodiment deals with an example where the central control circuit 107 starts playing music when the first shutter switch 118 (SW1) is pressed, and stops playing music when the second shutter switch (SW2) is pressed. The digital camera 100 according to the present exemplary embodiment has the same configuration as in the first exemplary embodiment.

### Description Thereof Will Thus be Omitted.

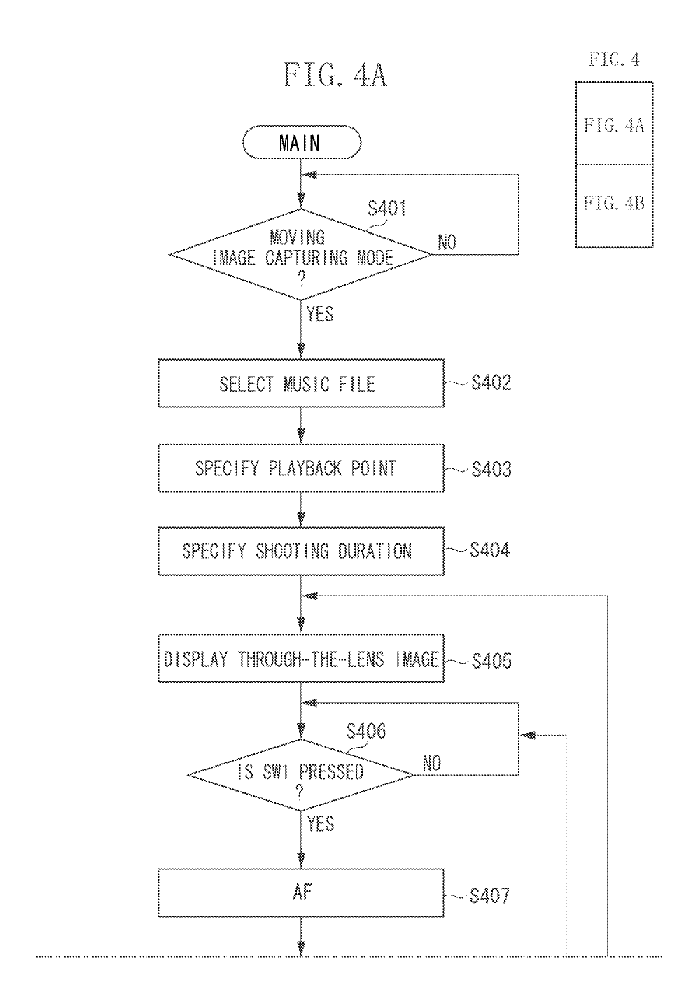

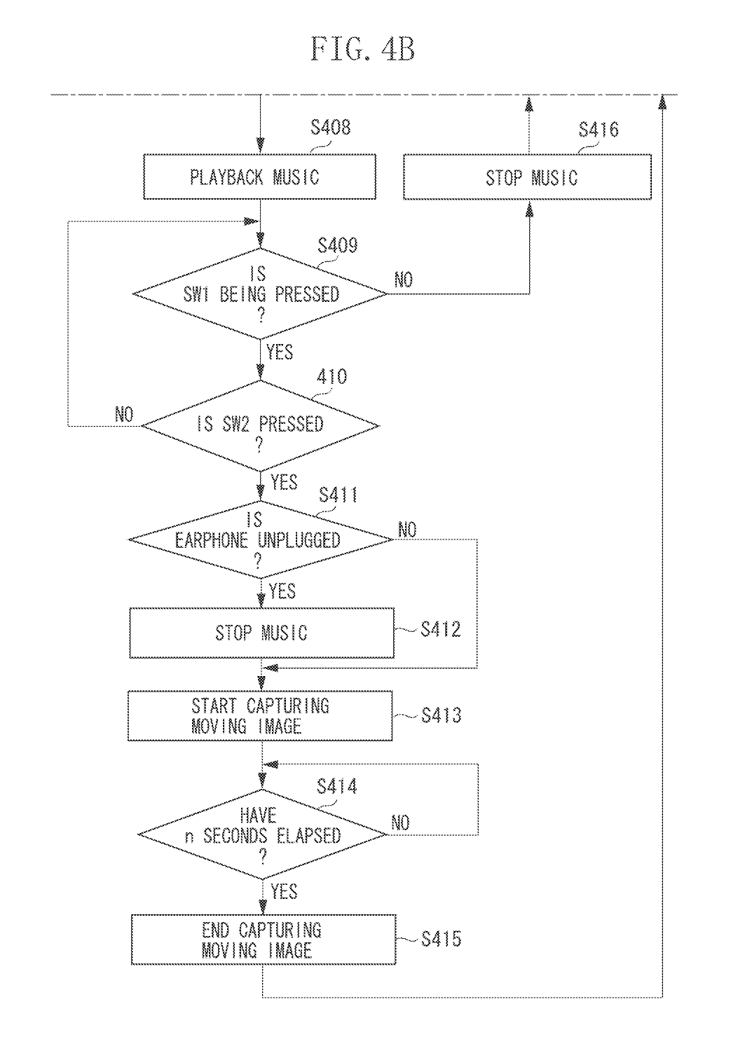

FIG. 4 is a flowchart illustrating an example of the processing for capturing a moving image. The processes illustrated in FIG. 4 are performed by the control of the central control unit 107. The processing of steps S401 to S405 is the same as that of steps S201 to S205 of FIG. 2, respectively. Description thereof will thus be omitted.

In step S406, the central control unit 107 waits until the user presses the first shutter switch 118 (SW1). If the first shutter switch 118 (SW1) is pressed (YES in step S406), then in step S407, the central control unit 107 performs AF processing by using the photographing control unit 139. The processing of step S407 is the same as that of step S210 in FIG. 2.

In step S408, the central control unit 107 reproduces the music file. The processing is the same as that of step S206 in FIG. 2. In step S409, the central control unit 107 then determines whether or not the first shutter switch 118 (SW1) is held down. If the first shutter switch 118 (SW1) is determined to be held down, i.e., continues to be pressed from step S406 (YES in S409), the central control unit 107 proceeds to step S410. On the other hand, if it is determined in step S409 that the first shutter switch 118 (SW1) stops being pressed (NO in step S409), the central control unit 107 proceeds to step S416. In step S416, the central control unit 107 stops reproducing the music file. The processing is the same as that of step S209 in FIG. 2. The central control unit 107 then returns to step S406.

In step S410, the central control unit 107 determines whether or not the second shutter switch 119 (SW2) is pressed. If the second shutter switch 119 (SW2) is determined to be pressed (YES in step S411), the central control unit 107 proceeds to step S411. If the second shutter switch 119 (SW2) is determined not to be pressed (NO in step S411), the central control unit 107 returns to step S409. Steps S411 and S412 are the same as steps S208 and S209 of FIG. 2, respectively. Steps S413 to S415 are the same as steps S213 to S215 of FIG. 2, respectively. The processing after the capturing of the moving image is also the same as in the first exemplary embodiment. Description thereof will thus be omitted.

As has been described above, according to the present exemplary embodiment, the central control unit 107 reproduces a music file when the first shutter switch 118 (SW1) is pressed, and stops reproducing the music file when the second shutter switch 119 (SW2) is pressed. This makes it possible to capture a moving image suited to sound as the user imagines, and prevent the sound from being recorded when the short-time moving image capturing mode is set.

Other aspects/embodiments of the present invention can also be realized by a computer of a system or apparatus (or devices such as a CPU or MPU) that reads out and executes a program and or computer readable instructions recorded on a memory device and or computer readable medium to perform the functions of the above-described embodiments, and by a method, the steps of which are performed by a computer of a system or apparatus by, for example, reading out and executing a program recorded on a memory device to perform the functions of the above-described embodiments for this purpose, the program is provided to the computer for example via a network or from a recording medium of various types serving as the memory device (for example, a non-transitory computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-209846 filed Sep. 17, 2010, which is hereby incorporated by reference herein in its entirety.

What is claimed is:

1. An image capturing apparatus comprising:
an image capturing unit configured to capture a moving image to generate moving image data;
a display control unit configured to display the moving image captured by the image capturing unit on a display unit;
a recording unit configured to record the moving image data generated by the image capturing unit onto a recording medium;
an instruction unit configured to issue an instruction for processing related to the the recording of the moving image data by the recording unit;
a reproduction unit configured to reproduce audio data to output sound from a speaker while the moving image is displayed on the display unit; and
a control unit configured to control the reproduction unit to stop outputting sound from the speaker when the instruction unit issues the instruction for the processing related to the the recording of the moving image data while the audio data is reproduced.

2. The image capturing apparatus according to claim 1, wherein the control unit controls the reproduction unit to restart outputting sound if the instruction issued by the instruction unit is cancelled before the instruction unit issues an instruction to start recording as the processing related to the recording.

3. The image capturing apparatus according to claim 1, wherein the control unit controls the reproduction unit to restart outputting sound after the recording unit ends recording the moving image data.

4. An image capturing apparatus comprising:
an image capturing unit configured to capture a moving image to generate moving image data;
a display control unit configured to display the moving image captured by the image capturing unit on a display unit;
a recording unit configured to record the moving image data generated by the image capturing unit onto a recording medium;
a first instruction unit configured to issue an instruction for processing related to preparation for the recording of the moving image data by the recording unit;
a second instruction unit configured to issue an instruction to start the recording of the moving image data by the recording unit;
a reproduction unit configured to reproduce audio data to output sound from a speaker when the first instruction unit issues the instruction for the processing related to the preparation for the the recording of the moving image data while the moving image is displayed on the display unit; and
a control unit configured to control the reproduction unit to stop outputting sound from the speaker when the second instruction unit issues the instruction to start recording the moving image data while the audio data is reproduced.

5. The image capturing apparatus according to claim 4, wherein the control unit controls the reproduction unit to stop outputting sound if the instruction issued by the first instruction unit is cancelled before the second instruction unit issues the instruction to start recording.

6. The image capturing apparatus according to claim 4, wherein the first instruction unit issues an instruction for automatic focus processing as the processing related to preparation for the the recording of the moving image data.

7. The image capturing apparatus according to claim 1, wherein the recording unit starts recording the moving image data after sound stops being output.

8. The image capturing apparatus according to claim 1, wherein the recording unit records the moving image data generated by the image capturing unit and the audio data reproduced by the reproduction unit onto the recording medium in association with each other.

9. An image capturing method comprising:
capturing a moving image to generate moving image data;
controlling display of the captured moving image on a display unit;
recording the generated moving image data on a recording medium;
issuing an instruction for processing related to the the recording of the moving image data;
reproducing audio data to output sound from a speaker while the moving image is displayed on the display unit; and
controlling the reproducing to stop outputting sound from the speaker when the instruction for the processing related to the the recording of the moving image data is issued while the audio data is reproduced.

10. An image capturing method comprising:
capturing a moving image to generate moving image data;
displaying the captured moving image on a display unit;
recording the generated moving image data on a recording medium;
first instructing of issuing an instruction for processing related to preparation for the recording of the moving image data by the recording;
second instructing of issuing an instruction to start recording the moving image data in the recording;
reproducing audio data to output sound from a speaker when the instruction for the processing related to preparation for the the recording of the moving image data is issued by the first instructing while the moving image is displayed on the display unit; and
controlling the reproducing to stop outputting sound from the speaker when the instruction to start recording the moving image data is issued by the second instructing while the audio data is reproduced.

11. A non-transitory computer readable medium containing computer-executable instructions for controlling an image capturing apparatus having a processor and memory that executes the computer-executable instructions, the medium comprising:
computer-executable instructions that capture a moving image to generate moving image data;
computer-executable instructions that display the captured moving image on a display unit;
computer-executable instructions that record the generated moving image data on a recording medium;
computer-executable instructions that issue an instruction for processing related to the recording of the moving image data by the recording;
computer-executable instructions that reproduce audio data to output sound from a speaker while the moving image is displayed on the display unit; and
computer-executable instructions that control the reproducing to stop outputting sound from the speaker when the instruction for the processing related to the the recording of the moving image data is issued while the audio data is reproduced.

12. A non-transitory computer readable medium containing computer-executable instructions for controlling an image capturing apparatus having a processor and memory that executes the computer-executable instructions, the medium comprising:
computer-executable instructions that capture a moving image to generate moving image data;
computer-executable instructions that display the captured moving image on a display unit;
computer-executable instructions that record the generated moving image data on a recording medium;
computer-executable instructions that first instruct issuing of an instruction for processing related to preparation for the the recording of the moving image data;
computer-executable instructions that second instruct issuing of an instruction to start recording the moving image data in the recording;
computer-executable instructions that reproduce audio data to output sound from a speaker when the instruction for the processing related to preparation for the the recording of the moving image data is issued by the first instructing while the moving image is displayed on the display unit; and
computer-executable instructions that control the reproducing to stop outputting sound from the speaker when the instruction to start recording the moving image data is issued by the second instructing while the audio data is reproduced.
